(19) United States
(12) Patent Application Publication
(10) Pub. No.: US 2025/0127600 A1
(43) Pub. Date: Apr. 24, 2025

(54) Floss Applicator Device with Dual Floss Receiving Ports

(71) Applicant: Parallel Capture Brands, Inc., Wilton, CT (US)

(72) Inventor: Brett W. Thornton, Wilton, CT (US)

(21) Appl. No.: 18/721,859

(22) PCT Filed: Dec. 19, 2022
(86) PCT No.: PCT/US2022/081982

§ 371 Date: Jun. 19, 2024

Related U.S. Application Data
(60) Provisional application No. 63/265,700, filed on Dec. 19, 2021.

(51) Int. Cl. A61C 15/04

(52) U.S. Cl. CPC A61C 15/046

(57) ABSTRACT

A device for dispensing interdental cleaner strands, the device comprising, in some embodiments, a front end for dispensing an interdental cleaner strand and plurality of threader ports for communicating the interdental cleaner strand into the front end. In one example, a rotating wheel may be operated by a user to advance an interdental cleaner strand into one or more threader ports.

### CROSS-REFERENCE TO RELATED APPLICATIONS

The present application claims the benefit of priority of U.S. Provisional Patent Application No. 63/265,700 filed Dec. 19, 2021, entitled “Floss Applicator Device with Dual Floss Receiving Ports,” which is incorporated by reference in the present application.

### FIELD OF THE INVENTION

The present invention is directed to devices for dispensing and/or applying interdental and interproximal cleaners such as bridge and implant cleaners, dental floss, yarn-based cleaner strands, and the like.

### BACKGROUND

Various types of dental floss applicators are known for dispensing conventional dental floss for cleaning the interproximal spaces between adjacent teeth and for massaging the gums at the interproximal. However, despite the importance of dental hygiene and ease of use for encouraging proper flossing, known dental floss applicators and dispensers fail to provide easy-to-use devices that allow a user to hold an applicator comfortably in different orientations when dispensing floss at and/or into interproximal spaces. Known devices also do not provide for efficient and effective means for applying cleaners that have a rigid or “threader” portion, or for applying a rigid floss threader tool combined with conventional dental floss.

### BRIEF DESCRIPTION OF THE DRAWINGS

An understanding of embodiments described in this disclosure and many of the related advantages may be readily obtained by reference to the following detailed description when considered with the accompanying drawings, of which:

FIG. 1 is a perspective view of a floss applicator device according to some embodiments of the present invention;

FIG. 2 is a perspective view of a floss applicator device according to some embodiments of the present invention;

FIG. 3 is a perspective view focusing of the top of a floss applicator device according to some embodiments of the present invention;

FIG. 4 is a top elevation view of a floss applicator device according to some embodiments of the present invention;

FIG. 5 is a bottom elevation view of the floss applicator device of FIG. 1 according to some embodiments of the present invention;

FIG. 6 is a side plan view of a floss applicator device according to some embodiments of the present invention;

FIG. 7 is a front plan view of a floss applicator device according to some embodiments of the present invention;

FIG. 8 is a rear plan view of a floss applicator device according to some embodiments of the present invention;

FIG. 9A is a diagram depicting example use of a floss applicator device according to some embodiments of the present invention;

FIG. 9B is a diagram depicting example use of a floss applicator device according to some embodiments of the present invention; and

FIG. 10 is an exploded view of a floss applicator device according to some embodiments of the present invention.

### DETAILED DESCRIPTION

In accordance with some embodiments of the present invention, a floss dispensing and/or application device is provided that is configured for advancement of a length of floss for use in cleaning interdental and/or interproximal spaces.

In accordance with some embodiments of the present invention, a hand-held floss dispensing and/or application device is provided that is configured for manual advancement of a length of floss using a finger or thumb.

According to some embodiments, a hand-held floss dispensing and/or application device is provided that comprises at least two ports from which a user may select for advancing the floss (e.g., manually) into a delivering portion of the device (e.g., an applicator portion having a bore). Advantageously, the device allows for the user to hold the device in an optimal position (e.g., sideways, angled up, angled down) for applying the floss to a desired interproximal location (e.g., to the top row of teeth, the bottom row of teeth, front teeth, side teeth, or rearmost teeth).

In accordance with some embodiments of the present invention, articles of manufacture provide a floss dispensing and/or application device comprising:
a) a dispensing opening for dispensing floss;
b) at least two receiving ports for receiving floss, each of the at least two receiving ports being connected to the dispensing opening; and
c) a surface against which a user can press and advance floss (e.g., using a finger, thumb, or other digit) into at least one of the at least two receiving ports.

In accordance with some embodiments of the present invention, articles of manufacture provide a floss dispensing and/or application device comprising:
a) a dispensing opening for dispensing floss;
b) a first receiving port for receiving floss for communication to the dispensing opening;
c) a second receiving port for receiving floss for communication to the dispensing opening; and
d) a movable surface movable by a user and against which the user is able to press floss and able to advance floss into the first receiving port or second receiving port by moving the movable surface and the floss pressed against the movable surface.

According to some embodiments, the movable surface is a rotatable surface, such as a wheel or other object having an axis rotatably affixed to the device. According to some embodiments, the movable surface is movable by a user by using a digit such as a finger or thumb (e.g., to rotate a wheel). According to some embodiments, a user may use a finger or thumb to hold floss against a wheel and, by moving their digit in the direction of a receiving port, rotate the wheel, thereby advancing floss pressed between their digit and the wheel, in the direction of (and into) the receiving port. The user may repeat the motion by lifting and returning their digit to a starting position, again pressing the floss, and again rotating the wheel to advance the floss, and so on, repeating this flicking or rotating motion as necessary to advance the desired length of floss through the preferred receiving port and to the dispensing opening.

In accordance with some embodiments of the present invention, articles of manufacture provide a floss dispensing and/or application device comprising:
a) a conically-or funnel-shaped front end with a bore for dispensing floss;
b) a first floss receiving port for receiving floss into the front end;
c) a second floss receiving port for receiving floss into the front end; and
d) a surface against which a user can advance floss into the first floss receiving port and/or the second floss receiving port.

In accordance with some embodiments of the present invention, a floss dispensing and/or application device further comprises one or more of the following features:
a) a handle;
b) a first threading guide for guiding floss into the first floss receiving port;
c) a second threading guide for guiding floss into the second floss receiving port;
d) a surface for a user to press floss against when advancing floss manually into the first floss receiving port and/or second floss receiving port;
e) wherein the surface is embodied as a rotatable wheel configured to allow a user to press floss against the wheel and rotate the wheel to advance floss manually into the first floss receiving port or the second floss receiving port (e.g., depending on whether the floss is run over or under the wheel); and/or
f) wherein the surface comprises a channel for receiving and guiding floss into a floss receiving port.

In accordance with some embodiments of the present invention, a system is provided comprising one or more of the following:
a) a floss applicator device comprising at least two floss receiving ports for receiving floss;
b) wherein the floss may comprise a rigid threader portion (e.g., at an end of the strand of floss) for inserting into a floss receiving port; and/or
c) wherein the floss may comprise conventional dental floss (e.g., dental floss without a rigid threader portion) connected to a rigid threader tool for inserting into a floss receiving port.

In accordance with some embodiments of the present invention, a method is provided for using a floss dispensing device having more than one floss receiving port, the method comprising:
a) selecting one of a first floss receiving port or a second floss receiving port of the floss dispensing device;
b) inserting a lead end of a strand of floss into the selected floss receiving port;
c) using the same hand as is being used to hold the floss dispensing device, advancing the strand of floss into the selected floss receiving port until it exits a dispensing opening of the floss dispensing device.

In accordance with some embodiments of the present invention, a method is provided for using a floss dispensing device having more than one floss receiving port, the method comprising:
a) performing, by a user, one of:
   (i) inserting a lead end of a strand of floss into a first floss receiving port, and
   (ii) holding the floss dispensing device so the user's thumb can press the floss against a first side of a wheel and rotate the wheel for advancing the floss into the first floss receiving port; OR
   (i) inserting a lead end of a strand of floss into a second floss receiving port, and
   (ii) holding the floss dispensing device so the user's thumb can press the floss against a second side of a wheel and rotate the wheel for advancing the floss into the second floss receiving port,
wherein both the first floss receiving port and the second floss receiving port are in communication with a dispensing opening of a floss dispensing device;
b) aligning the floss with a channel for receiving and guiding floss into the selected floss receiving port;
c) inserting the floss through a threading guide for aligning the floss with the wheel as the floss advances to engage the wheel; and/or
d) orienting the floss dispensing device using the same hand as is being used to hold the floss dispensing device, advancing the strand of floss into the selected floss receiving port until it exits a dispensing opening of the floss dispensing device.

In accordance with some embodiments of the present invention, a floss dispensing and/or application device is provided that is configured for manual advancement of a length of floss using a finger or thumb. According to some embodiments, the device comprises at least two ports from which a user may select for advancing the floss into a delivering portion of the device (e.g., an applicator portion having a bore). Advantageously, the device allows for the user to hold the device in an optimal position (e.g., sideways, angled up, angled down) for applying the floss to a desired location (e.g., to the top row of teeth, the bottom row of teeth, front teeth, side teeth, or rearmost teeth).

In accordance with some embodiments, a dispensing and/or application device providing for one or more functions described in this application does not comprise a portion, such as a supply reel, for storing and/or providing floss. According to some embodiments, a floss dispensing and/or application device providing for one or more functions described in this disclosure does not comprise a portion, such as a take-up reel, for receiving and storing used floss. According to some embodiments, a floss dispensing and/or application device providing for one or more functions described in this disclosure does not comprise either a supply reel or a take-up reel.

According to some embodiments, a dispensing and/or application device is not configured to provide tension to floss while the floss is being applied and/or while the interdental cleaner is being used for cleaning.

According to some embodiments, a dispensing and/or application device is configured such that a length of interdental cleaner (e.g., a piece of floss) may be fully removed from the device after the interdental cleaner is applied to an interproximal space and before the user begins and/or completes flossing with the interdental cleaner.

### A. Example Devices and Methods

References in this disclosure to “floss” or “dental floss” are intended to encompass various types of interdental and interproximal cleaners, including but not limited to cleaning strands of nylon, monofilament, multiple filament threads, yarn, conventional dental floss (e.g., waxed dental floss such as Oral-B™ Glide™ or unwaxed dental floss such as GUM Butler Weave), combination stiff threader and floss products (e.g., ProxySoft™ bridge and implant cleaners or Oral-B™ Glide™ Pro-Health™ threader floss), and the like.

References in this disclosure to “threader with floss” or “combination threader and floss” or “threader floss” or “rigid interdental insert” means (1) floss characterized by having a stiff or less flexible threader portion (e.g., for inserting into interdental or other types of interproximal spaces) and a flexible floss and/or brush portion (e.g., ProxySoft™ bridge and implant cleaners); and/or (2) a rigid threader tool (e.g., DenTek™ floss threaders) in combination with and/or connected to a strand of conventional floss (e.g., to be inserted into and then used to pull the conventional floss through interproximal spaces).

In accordance with various embodiments of the present invention, a device for dispensing and/or applying threader floss and other types of interdental cleaners is provided. Although the device may be most effective with combination threader and floss, it may be useful, in some embodiments, for applying other types of dental floss as well. In accordance with some embodiments, the device has a curved front end from which the floss is dispensed, advantageously allowing for a user to orient the curved front end of the device to direct the insertion of floss at a desired interproximal location (e.g., between two teeth). In one example, a user may desire to hold the device in her right hand and dispense floss at an interproximal space on the outer side of the user's teeth on the left, and, accordingly, may want the curved end of the dispensing device to curve toward the user's right when held with the right hand. In such a case, the user may hold the floss dispensing device so that the user's right thumb is in contact with the floss and pressing the floss against the bottom side of a floss advancement wheel while rotating the wheel with the thumb to advance the floss into a lower floss receiving port on the device and thus out of a dispensing opening in the front end.

In another example, the user, still preferring to hold the device in her right hand, wishes to dispense floss at an interproximal space on the inner side of the user's teeth on the left, and, accordingly, may want the curved end of the dispensing device to curve generally toward the user's left when held with the right hand. In such a case, the user may insert the floss through another (upper) floss receiving port and hold the floss dispensing device so that the user's right thumb is in contact with the floss and pressing the floss against the top side of a floss advancement wheel while rotating the wheel with the thumb to advance the floss into the upper floss receiving port on the device.

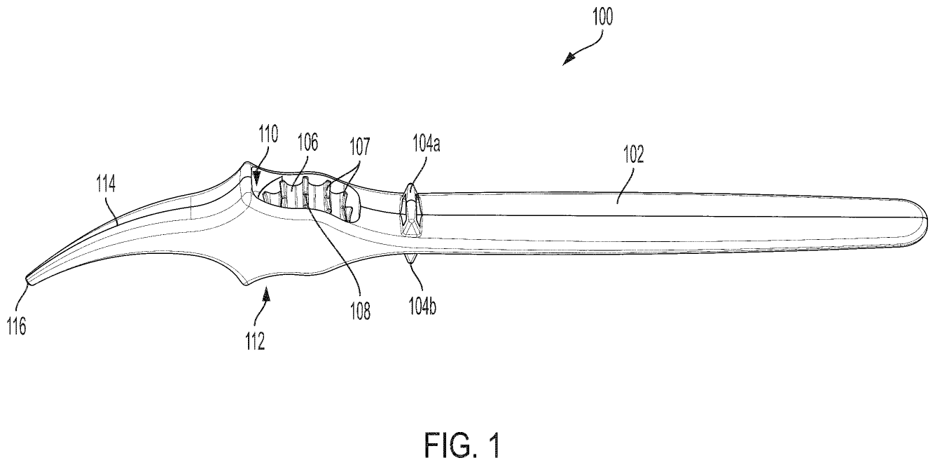

Some features in accordance with some embodiments of the present invention are described below with respect to the figures. Referring to FIG. 1, a floss threading device 100 comprises a handle 102 and floss threading guides 104a (upper) and 104b (lower) for guiding floss to engage wheel 106 and into either floss receiving port 110 (e.g., upper) or floss receiving port 112 (e.g., lower). In accordance with some embodiments, the wheel 106 is configured in the floss threading device 100 to be accessible to a user (e.g., for using the wheel 106 to advance floss).

Both floss receiving port 110 and floss receiving port 112 lead and provide passage for inserted floss (not shown) to the interior of end 114 (interior not shown). End 114 is connected to both floss receiving port 110 and floss receiving port 112, such that floss advanced into either of floss receiving port 110 and floss receiving port 112 enters end 114. End 114 provides passage for the inserted floss as it is advanced to the bore or dispensing opening 116, from which floss is dispensed (e.g., at an interproximal location such as between a user's teeth).

In accordance with some embodiments, floss receiving port 110 and floss receiving port 112 may be separated by a dividing portion (not shown). In other embodiments, the floss receiving ports 110, 112 may not be separated structurally but may be defined by how floss is inserted (e.g., by running floss over or under the wheel 106).

In one embodiment, the wheel 106 comprises one or more ridges 107 to improve engagement of a user's finger or thumb with the wheel 106 when rotating the wheel 106. In some embodiments, the wheel may comprise a groove or channel 108 for retaining the floss as it engages the wheel 108 and is advanced by action of the user (e.g., using a thumb or finger) by rotating the wheel.

According to some embodiments, the floss dispensing device does not comprise a wheel but is configured with a surface (e.g., integrated with handle 102) against which a user can press the floss to advance along the longitudinal axis and into one of the multiple floss receiving ports.

According to some embodiments, the floss dispensing device may comprise more than two floss receiving ports to provide additional options for comfort and ease of use in accordance with a user's personal preference.

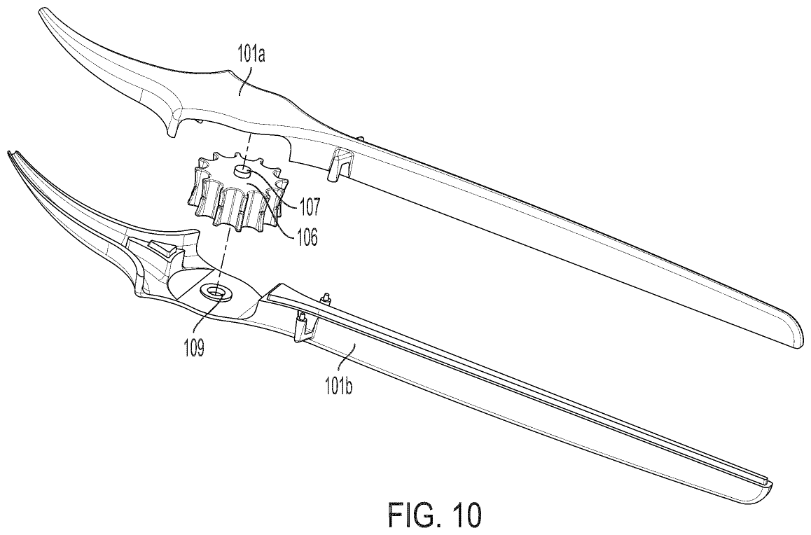

According to some embodiments, a floss dispensing device may be formed of any suitable material appropriate for handling by a user and for applications of floss into a user's mouth and to other interproximal space. A floss dispensing device may be formed, for example, using plastic, nylon, metal, wood, and/or any combination of such materials. An example exploded view of a floss dispensing device is discussed below with respect to FIG. 10.

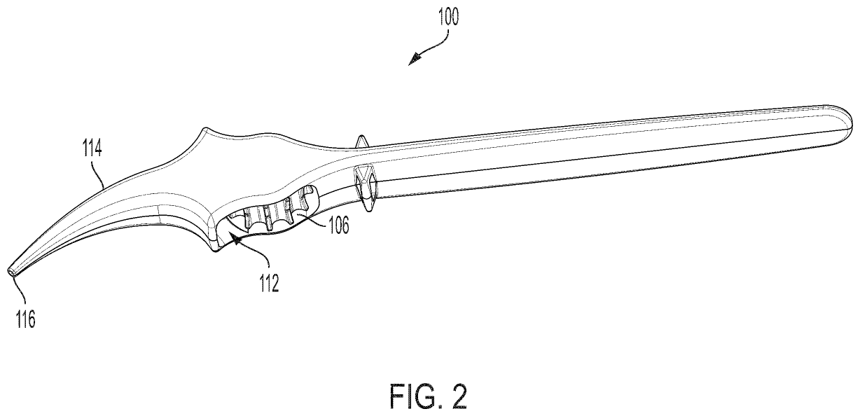

FIG. 2 depicts an alternative view of the floss threading device 100 of FIG. 1. As shown in FIG. 1, the wheel 106 may be accessible to a user on a first side of the floss dispensing device 100 (e.g., an upper side, as shown in FIG. 1); as shown in FIG. 2, the wheel 106 may also be accessible on a second side of the floss dispensing device 100 (e.g., via a port opposite the first side, as shown in FIG. 2). Accordingly, a user may be able to advance floss using the wheel 106 through floss receiving port 112 into end 114, and out dispensing opening 116. Accordingly, a floss dispensing device 100, configured with dual floss receiving ports 110, 112 and dual access to a wheel 106—on either side of the floss dispensing device 100—allows a user to choose how to input floss to the floss dispensing device, according to the user's preference, comfort, and ease of use for a particular floss application.

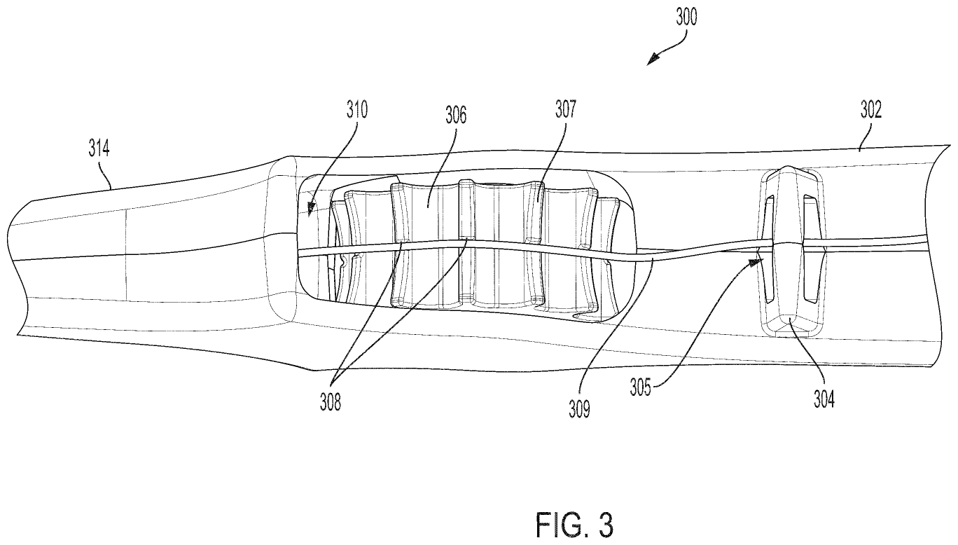

FIG. 3. depicts a close-up view of a portion of an example floss dispensing device 300 in accordance with some embodiments. As depicted in FIG. 3, the floss dispensing device 300 may comprise handle 302 connected to a floss threading guide 304. The floss threading guide 304 (also referred to a floss “loop”) defines a guide opening 305 for optionally receiving floss 309 that a user wishes to apply using the floss dispensing device 300. The guide opening 305 may advantageously assist in lining up the floss 309 for insertion in the floss receiving port 310 and/or for laying the floss 309 across the wheel 306. For example, to use the floss dispensing device 300, a user could optionally thread the lead end of the piece of floss 309 through the guide opening 305 (from right to left in the view of FIG. 3), before inserting the lead end of the piece of floss 309 into the floss receiving port 310, and then laying the lead end of the piece of floss 309 over the top of wheel 306, securing the floss 309 in place against the wheel 306 with their thumb or other digit (not shown). In another example, a user may elect not to use the floss threading guide 304 (if available). In another example, a user may elect to first secure a portion of the floss 309 in place on the wheel 306 before feeding a lead end of the floss 309 through the floss receiving port 310.

In one or more embodiments, the wheel 306 comprises a channel 308 defined, for example, by depressions, grooves, or notches in the surface of the wheel 306. For example, as shown in FIG. 3, the channel 308 may be defined by one or more notches substantially in the center of the one or more ridges 307 of the wheel 306 that the user may use to rotate the wheel 306.

In some embodiments, the one or more ridges 307 may have a concave shape for assisting in keeping the floss 309 in place atop the wheel 306 while the user is advancing the floss 309. In accordance with some embodiments, the top surface of the wheel 306 and/or each ridge 307 may be slightly concave and have a groove in the middle to assist in keeping the threader portion of threader floss positioned correctly (e.g., in the middle of the wheel ridge 307) for greater ease of operation when advancing the threader between the thumb and wheel 307. In one or more embodiments, the wheel 306 does not comprise any channel, does not have a concave feature, and/or does not comprise any ridges.

Continuing with the example of setting up a piece of floss 309 for dispensing, a user may, using a thumb or finger (not shown), press the floss 309 laying atop the wheel 306 and rotate the wheel 306 toward the floss receiving port 310 (e.g., by moving their digit from right to left in the view of FIG. 3). In this way, a user may effectively push or otherwise advance the floss 309 further into the floss receiving port 310 and thus further into the end 314 and toward a dispensing opening (not shown; see, e.g., dispensing opening 116 of FIG. 1), assisted by the rotation of the wheel 306.

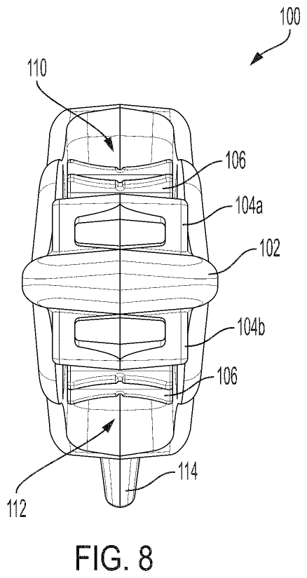

In accordance with some embodiments, a floss receiving port (e.g., floss receiving port 110, floss receiving port 112, and/or floss receiving port 310) may be configured with a dimension height—defined as the distance between a wheel and the interior surface of the outermost structure of the floss dispensing device—large enough to advantageously provide for an easier target for a user attempting to insert floss in the floss receiving port. For instance, the example floss dispensing device 100, as depicted in FIGS. 1 and 2, has a curved or “flared” shape proximate floss receiving port 110 and 112 and the wheel 106, providing a wider gap for inserting floss. An example of an easier-to-use floss receiving port resulting from this curved shape may be considered in FIG. 8, showing the relative height of floss receiving port 110.

Accordingly, some embodiments of a floss dispensing device provide for a curved portion proximate to and defining a corresponding floss receiving port. In one or more embodiments, a floss dispensing device comprises at least one flared portion, each flared portion defining a corresponding floss receiving port. According to some embodiments, a widest transverse portion of a floss dispensing device defines the depth of at least one floss receiving port; in some embodiments, the widest transverse portion is wider than a wheel of the floss dispensing device.

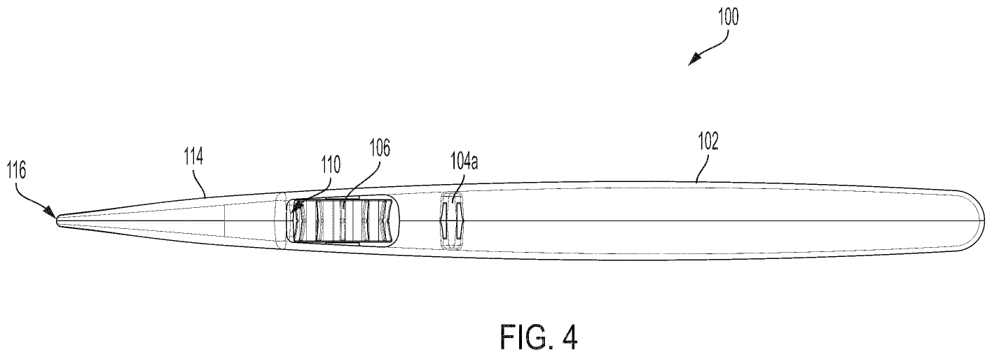

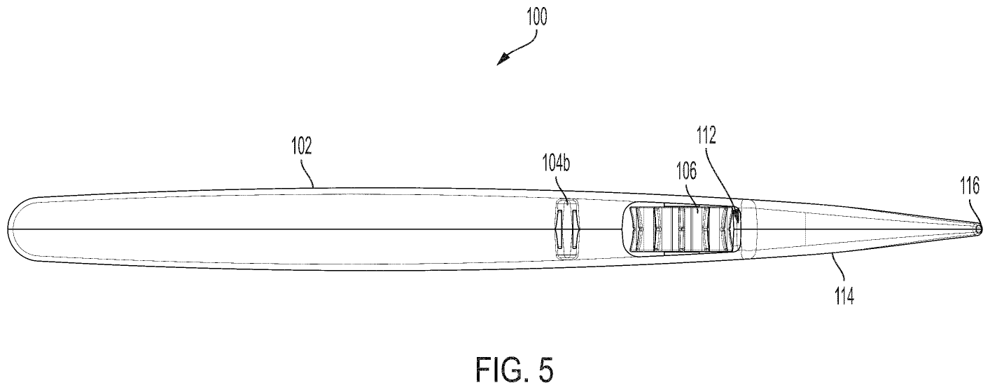

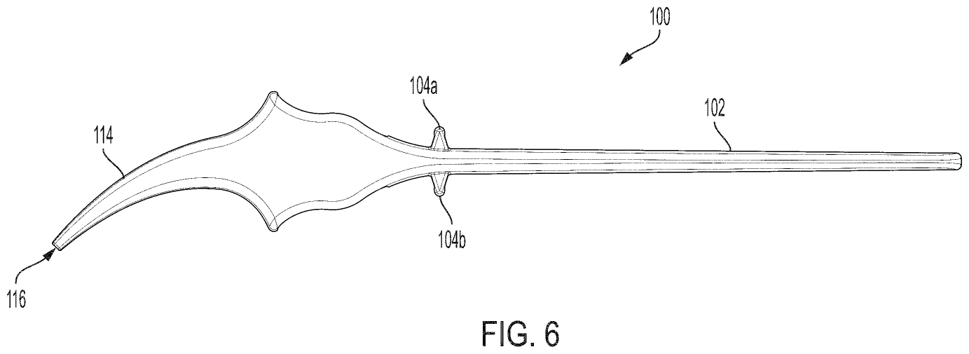

FIG. 4 depicts an alternative (top) view of the example floss dispensing device 100 of FIG. 1; FIG. 5 depicts an alternative (bottom) view of the example floss dispensing device 100 of FIG. 1; and FIG. 6 depicts an alternative (side) view of the example floss dispensing device 100 of FIG. 1.

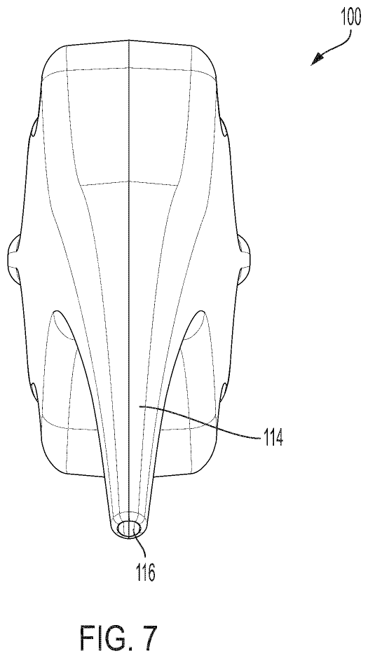

FIG. 7 depicts a front view of the example floss dispensing device 100 of FIG. 1, showing in particular, at the terminus of the end 114, the bore or dispensing opening 116 from which floss may be dispensed in accordance with some embodiments described in this disclosure. FIG. 8 depicts a rear view of the example floss dispensing device 100 of FIG. 1, showing dual access to the wheel 106, the first floss receiving port 110, and the second floss receiving port 112.

In accordance with some embodiments described in this disclosure, a dispensing device provides for hybrid feeding action for feeding floss. In order to advance threader floss (or other type of floss) into the intended area of the mouth, the user's thumb is preferably directly engaged with the threader, such as by pressing, with the thumb, the threader against the wheel. In this way the threader may be advanced through a front end, or feeder snout, not automatically by the device, nor solely by the user's thumb, but by the threader being trapped in between the hybrid action of the user's thumb pad and the wheel. This combined action ability advantageously enables the user to have much great control over the threader and its application to a desired location. The control achieved by the hybrid action is markedly greater than if, for example, the threader were being fed into opposing gears or rollers, or by a single gear or roller against a static surface.

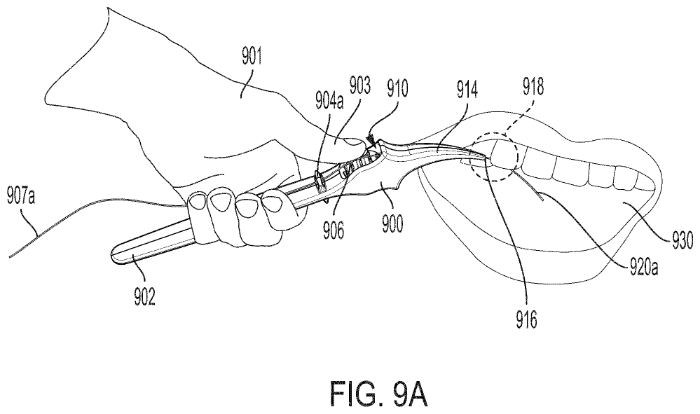

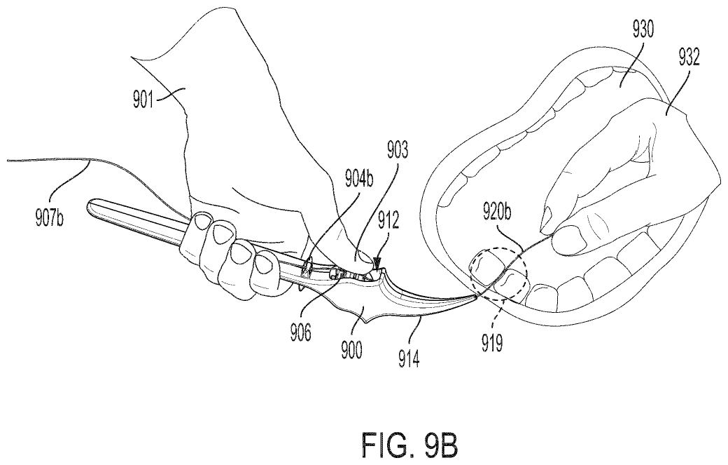

FIG. 9A depicts a view of an example use of a floss dispensing device to apply floss in a user's mouth, in accordance with one or more embodiments. According to the example use depicted in FIG. 9A, after setting up floss 907a in the floss dispensing device 900 (e.g., as described with respect to FIG. 3) by threading the floss 907a through floss threading guide 904a, a user holding the floss dispensing device 900 in their hand 901 may use their thumb 903 (or other digit), while holding the handle 902, to press the floss 907a against the wheel 906. The user may then advance the floss 907a further into the receiving port 910 by rolling or flicking the wheel 906 and the floss 907a toward the receiving port 910, thereby pushing the floss 907a into end 914 and out dispensing opening 916. In this way, the user can apply the lead end 920a of the floss 907a at and into a desired interproximal space 918 (e.g., between two teeth in the user's mouth 930). The user may then be able to grasp the lead end 920a (e.g., using another hand (not shown)) and begin using the floss 907a to clean the interproximal space 918.

In the example use depicted in the view of FIG. 9A, the user utilizes the wheel 906, the floss threading guide 904a, and a first floss receiving port 910 of the example floss dispensing device 900, to apply the floss 907a to an upper part of the user's mouth 930. In another example use, as depicted in the view of FIG. 9B, the user may prefer to hold the floss dispensing device 900 differently to reach a different interproximal space 919. Because, as discussed in this disclosure, the floss dispensing device 900 may provide dual access to the wheel 906 and/or provides dual floss receiving ports in accordance with some embodiments, the user is able to select the way the user wishes to hold the device 900. As depicted in FIG. 9B, the user elects to hold the floss dispensing device 900 rotated and/or inverted relative to the use depicted in FIG. 9A, and to use a different opening to access the wheel 906 to advance floss through a second floss receiving port 912.

Specifically, in the example use depicted in FIG. 9B, the user has fed the floss 907b through a different floss threading guide 904b, over a different side of wheel 906 (accessed using a different opening in the device 900), and into a different floss receiving port 912. The user is able to advance the lead end 920b of floss 907b through end 914, out dispensing opening 916, and into interproximal space 919, by using wheel 906 to advance the floss 907b in a manner similar to the process described with respect to FIG. 9B. The user may use another hand 932 to grab the lead end 920b and remove the floss 907b completely from the device 900 and/or to begin flossing at the interproximal space 919.

FIG. 10 depicts an exploded view of an example floss dispensing device, such as example floss dispensing device 100 of FIG. 1, in accordance with some embodiments. A floss dispensing device may be formed, as shown in FIG. 10, of substantially similar pieces. In FIG. 10, the example floss dispensing device comprises two pieces 101a, 101b that are substantially similar to one another. One half may be configured with securing means configured for connecting with corresponding securing means on the other half. In the example of FIG. 10, posts on the floss guide portion of piece 101b may be configured to snap into corresponding holes (not shown) of piece 101b for securing piece 101a and piece 101b together.

As depicted in FIG. 10, the wheel 106 may be rotatably secured between the two pieces 101a, 101b by fitting axis portions into corresponding axis slots in each piece 101, 101b. For example, as depicted in FIG. 10, the axis portion on the underside of wheel 106 (not shown in FIG. 10) would fit into corresponding axis slot 109 on piece 101b; similarly, an axis slot (not shown) on the underside of piece 101a could receive the axis portion 107. Preferably, the pieces 101a, 101b are configured to be securable together with the wheel 106 between them such that wheel 106 is able to rotate freely (e.g., when pressure is applied by a user's thumb). While the depiction in FIG. 10 shows the axis portions (e.g., axis portion 107) would be fully contained within the device formed by pieces 101a, 101b, according to some alternative embodiments, an axis portion may be configured to extend partially or completely through an exterior side of a piece (e.g., piece 101b). In one embodiment, an axis slot may go fully through the exterior side of a piece.

In accordance with some embodiments, a floss dispensing device is provided having a dual port design that allows a user a wide range (e.g., 180 degrees) of insertion angle choice, while enabling them to keep their thumb comfortably and ergonomically correctly facing toward them. Regardless of which port the user chooses (e.g., an upper or a lower port) for feeding floss into the device, the user is able to maintain the thumb-on-gear action static. The range of freedom includes the feeder snout facing away from or toward the user's intended area of mouth.

According to some embodiments, a method of using a floss dispensing device to apply floss for cleaning teeth may comprise: grasping the lead end of a piece of threader floss (or other type of floss) (e.g., the rigid, lead end of threader floss) between thumb and forefinger, guide the end into one of the one or more floss receiving ports on the device; placing the dispensing opening (also referred to as a feeder snout or feeder tube) of the device at an interdental space or other interproximal space (e.g., for cleaning braces and/or other types of fixtures) of the mouth where flossing is desired; advancing the end of the threader floss by turning the wheel with a thumb pressing the threader floss against the wheel; and once the end of the threader floss passes through the desired interproximal space, grasping the lead end between thumb and forefinger. The user may begin flossing, for example, by setting the device aside, grasping the other end of the threader floss with thumb and forefinger of the other hand, and flossing the interproximal space with the inserted threader floss in a typical manner.

### Interpretation

Numerous embodiments are described in this patent application and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention may be practiced with various modifications and alterations, such as structural, logical, software, and/or electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features that must be present in all embodiments.

Neither the Title (as may be set forth at the beginning of the first page of this disclosure) nor the Abstract (as may be set forth at the end of this disclosure) is to be taken as limiting in any way the scope of the disclosed invention(s).

Throughout the description and unless otherwise specified, the following terms may include and/or encompass the example meanings provided below. These terms and illustrative example meanings are provided to clarify the language selected to describe embodiments both in the specification and in the appended claims, and accordingly, are not intended to be limiting.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

The terms “the invention” and “the present invention” and the like mean “one or more embodiments of the present invention.”

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present disclosure, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car, and a wheel.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each process (whether called a method, algorithm or otherwise) inherently includes one or more steps, and therefore all references to a “step” or “steps” of a process have an inherent antecedent basis in the mere recitation of the term “process” or a like term. Accordingly, any reference in a claim to a “step” or “steps” of a process has sufficient antecedent basis.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

As used in this disclosure, a “user” may generally refer to any individual and/or entity that operates a user device.

A description of an embodiment with several components or features does not imply that any particular one of such components and/or features is required. On the contrary, a variety of optional components are described to illustrate the wide variety of possible embodiments of the present invention(s). Unless otherwise specified explicitly, no component and/or feature is essential or required.

Further, although process steps, algorithms or the like may be described or depicted in a sequential order, such processes may be configured to work in one or more different orders. In other words, any sequence or order of steps that may be explicitly described or depicted does not necessarily indicate a requirement that the steps be performed in that order. The steps of processes described in this disclosure may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications, does not imply that the illustrated process or any of its steps is necessary to the invention, and does not imply that the illustrated process is preferred.

While the present invention has been illustrated by a description of various embodiments and while these embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the general inventive concept.

The present disclosure provides, to one of ordinary skill in the art, an enabling description of several embodiments and/or inventions. Some of these embodiments and/or inventions may not be claimed in the present application but may nevertheless be claimed in one or more continuing applications that claim the benefit of priority of the present application. Applicant reserves the right to file additional applications to pursue patents for subject matter that has been disclosed and enabled but not claimed in the present application.

What is claimed is:

1. A device comprising:
a front end with an opening for dispensing floss;
a first floss receiving port for receiving floss into the front end;
a second floss receiving port for receiving floss into the front end; and
a surface against which a user can advance floss into the first floss receiving port and/or the second floss receiving port.

2. The device of claim 1, wherein the floss comprises a stiff threader portion and a flexible floss portion.

3. The device of claim 1, wherein the floss comprises a floss threader tool connected to a flexible floss strand.

4. The device of claim 1, wherein the surface is embodied as a rotatable wheel.

5. The device of claim 1, wherein the front end is curved.

6. The device of claim 1, further comprising a handle.

7. The device of claim 1, further comprising a threading guide for retaining floss before it engages with the surface.

8. A device comprising:
a front end with an opening for dispensing floss;
a floss receiving port for receiving floss into the front end; and
a wheel configured to be operable by a user to advance floss into the floss receiving port.

9. The device of claim 8, further comprising a second floss receiving port for receiving floss into the front end.

10. The device of claim 8, wherein the wheel is accessible from at least two sides of the device.

11. The device of claim 8, wherein the front end is curved.

12. The device of claim 8, further comprising a handle.

13. The device of claim 8, further comprising a plurality of floss threading guides for retaining floss before it engages with the surface.

14. The device of claim 8, wherein the floss receiving port is defined in part by an outwardly curving portion of the front end.

15. A device comprising:
a dispensing opening for dispensing floss;
a first receiving port, connected to the dispensing opening, for receiving floss for communication to the dispensing opening;
a second receiving port, connected to the dispensing opening, for receiving floss for communication to the dispensing opening; and
a movable surface proximate the first receiving port and the second receiving port and configured to be movable by a user to advance floss into the first receiving port or the second receiving port.

16. The device of claim 15, wherein the movable surface is accessible from at least two sides of the device.

17. The device of claim 15, further comprising a handle.

18. The device of claim 18, wherein the movable surface is embodied as a wheel rotatably affixed to the handle.

19. The device of claim 15, further comprising a plurality of floss threading guides for retaining floss before it engages with the surface.

20. The device of claim 15, wherein the first floss receiving port the second floss receiving port are defined in part by respective outward curving portions of the front end.
